(19) United States
(12) Patent Application Publication
(10) Pub. No.: US 2020/0148110 A1
(43) Pub. Date: May 14, 2020

(54) DRIVER ASSISTANCE SYSTEM HAVING REAR-VIEW CAMERA AND CROSS-TRAFFIC SENSOR SYSTEM WITH SIMULTANEOUS VIEW

(71) Applicant: Continental Automotive Systems, Inc., Auburn Hills, MI (US)

(72) Inventors: James Hockridge Critchley, Lake Orion, MI (US); Peter Lamprecht, Shelby Township, MI (US); Tony Moussa, Rochester Hills, MI (US)

(73) Assignee: Continental Automotive Systems, Inc., Auburn Hills, MI (US)

(21) Appl. No.: 16/185,980

(22) Filed: Nov. 9, 2018

(51) Int. Cl. B60R 1/00; G01S 13/93; G01S 13/86; G01S 13/89; H04N 7/18; G06T 19/00

(52) U.S. Cl. CPC B60R 1/00; G01S 13/931; G01S 13/867; G01S 13/89; H04N 7/183; G01S 2013/9364; G06T 19/003; B60R 2300/8066; B60R 2300/602; G01S 2013/9367; G06T 19/006

(57) ABSTRACT

A driver assistance system for a vehicle includes a rear-view camera constructed and arranged to obtain an image of an area behind a rear of the vehicle. A non-camera sensor system is constructed and arranged to obtain data regarding dynamic or static environmental features at opposing sides of the vehicle. An electronic control unit is electrically connected with the rear-view camera and with the sensor system. The electronic control unit is constructed and arranged to create an image from the data received from the sensor system. A display system is controlled by the electronic control unit and is constructed and arranged to display simultaneously to a driver of the vehicle at a single location, the image obtained by the rear-view camera and the image created by the electronic control system.

### FIELD

This invention relates to advanced driver assist systems and, in particular, to a system having a rear-view camera and a cross-traffic sensor system that provides the driver with a simultaneous view or indication of objects that may be behind and that may be crossing the vehicle.

### BACKGROUND

Current automotive rear cross-traffic protection systems utilize radar and are configured to provide warnings and intervene only upon imminent threats. This is done so that the alert does not become an annoyance. However, such systems provide little time for driver reaction and do little to increase the driver's situational awareness prior to the vehicle entering a potentially dangerous situation. The driver thus must rely on the warning function parameters determined by the OEM and cannot make his/her own judgement of such situations.

Rear-view cameras are required on all new U.S. vehicles. However, the camera field of view commonly covers only the immediate area directly behind the vehicle. Such a rear-view camera presents a difficult decision to be made by the driver. Should the driver's focus be on the camera view, which is often displayed on the center console or on the rear-view mirror, or should the driver turn around and look out the rear side windows to watch for cross-traffic? It is not possible to monitor both views at the same time.

Thus, there is a need to provide a driver assistance system having a rear-view camera and a cross-traffic sensor system that provides the driver with a simultaneous view or indication of objects that may be behind and that may be crossing the vehicle.

### SUMMARY

An object of an embodiment is to fulfill the need referred to above. In accordance with the principles of an embodiment, this objective is obtained by providing a driver assistance system for a vehicle that includes a rear-view camera constructed and arranged to obtain an image of an area behind a rear of the vehicle. A non-camera sensor system is constructed and arranged to obtain data regarding dynamic or static environmental features at opposing sides of the vehicle. An electronic control unit is electrically connected with the rear-view camera and with the sensor system. The electronic control unit is constructed and arranged to create an image from the data received from the sensor system. A display system is controlled by the electronic control unit and is constructed and arranged to display simultaneously to a driver of the vehicle at a single location, the image obtained by the rear-view camera and the image created by the electronic control system.

In accordance with another aspect of an embodiment, a method is provided for monitoring environmental features at opposing sides and at a rear of a vehicle. The method obtains, with a camera, a first image of an area behind a rear of the vehicle, and obtains, without a camera, data regarding dynamic or static environmental features at opposing sides of the vehicle. A second image is created from the obtained data. The first and second images are displayed simultaneously to a driver of the vehicle at a single location.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic illustration of a vehicle having a driver assistance system in accordance with an embodiment of the invention.

FIG. 2 is a display image from a vehicle's rear-view camera of the driver assistance system of FIG. 1.

FIG. 3 is a virtual 3D display image of data obtained by the cross-traffic sensor system data of the driver assistance system of FIG. 1.

FIG. 4 is view from a display screen of the driver assistance system of FIG. 1, showing simultaneously, the display images of FIGS. 2 and 3.

FIG. 5 is a view from a display screen of driver assistance system of FIG.1 showing a camera image and an image created from the sensor data combined into a single view.

FIG. 6 is a schematic illustration of an exemplary vehicle display system having a display screen showing the images of FIG. 4.

### DETAILED DESCRIPTION OF THE EXEMPLARY EMBODIMENTS

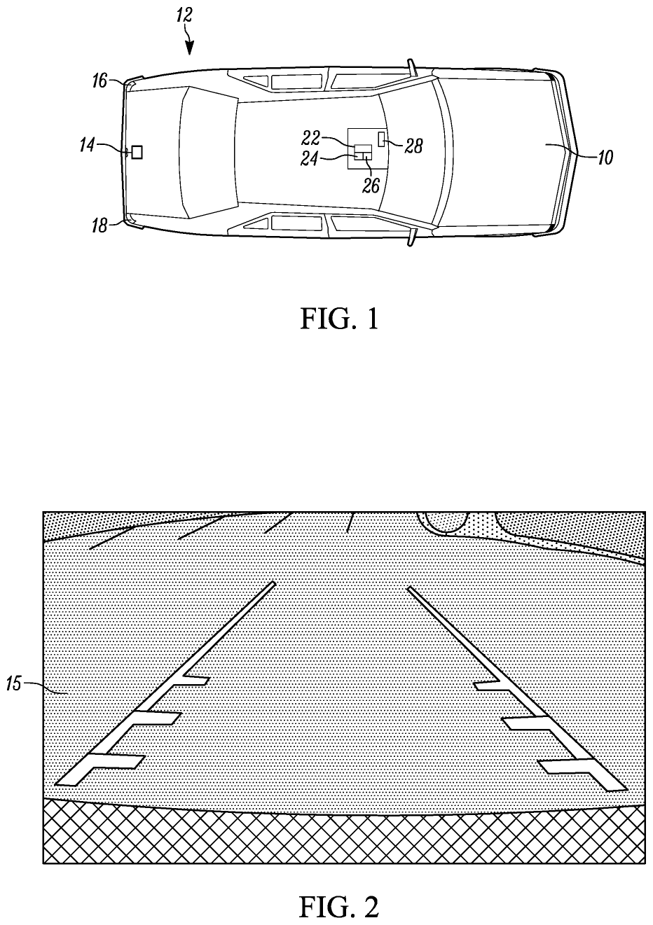

With reference to FIG. 1, a driver assistance system, for a vehicle 10, is shown generally indicated at 12 in accordance with an embodiment of the invention. The system 12 includes a rear-view camera 14 mounted to the rear of the vehicle 10 and constructed and arranged to obtain an image 15 (FIG. 2) of an area behind a rear of the vehicle 10.

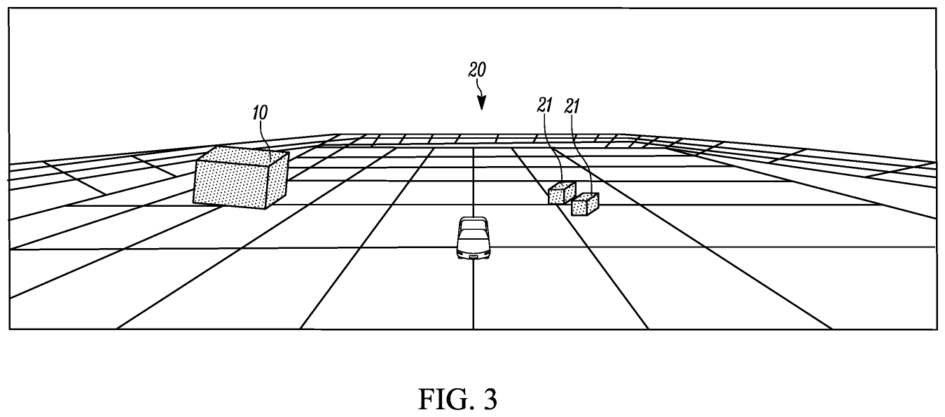

The system 10 includes a cross-traffic sensor system including at least sensors 16 and 18 mounted to opposing sides of the vehicle 10 and constructed and arranged to obtain data regarding dynamic or static environmental features at the sides of the vehicle 10. The sensors 16 and 18 are shown mounted to a rear of the vehicle but can be mounted anywhere on opposing sides of the vehicle 10. More than two sensors can be provided. The sensors 16, 18 are preferably conventional radar, lidar, ultrasonic, or other similar non-camera sensors. A virtual image of the data obtained by the sensors 16, 18 can be created and viewed by engineers as part of the sensor/function development process, but this virtual image is not presented to the end user in conventional driver assistance systems. The inventors realized, however, that this image data can be useful the driver assistance system 10. An example of this data as a virtual 3D image is shown generally indicated at 20 in FIG. 3, where a representation of the vehicle 10 and pedestrians 21 at a side of the vehicle are visible.

As shown in FIG. 1, the system 10 includes an electronic control unit (ECU) 22 to which the rear-view camera 14 and the sensors 16, 18 are electrically connected. The ECU 22 includes a processor circuit 24 constructed and arranged to create e the virtual 3D image 20 from the data received from the sensors 16 and 18 of the sensor system. In the absence of volumetric height information from the planar sensors 16, 18 (e.g., radar sensors), the processor circuit 24 can interpret the intensity of the return signal (radar cross-section) as a height of the object in the image 20. The ECU 22 also includes a memory circuit for storing data.

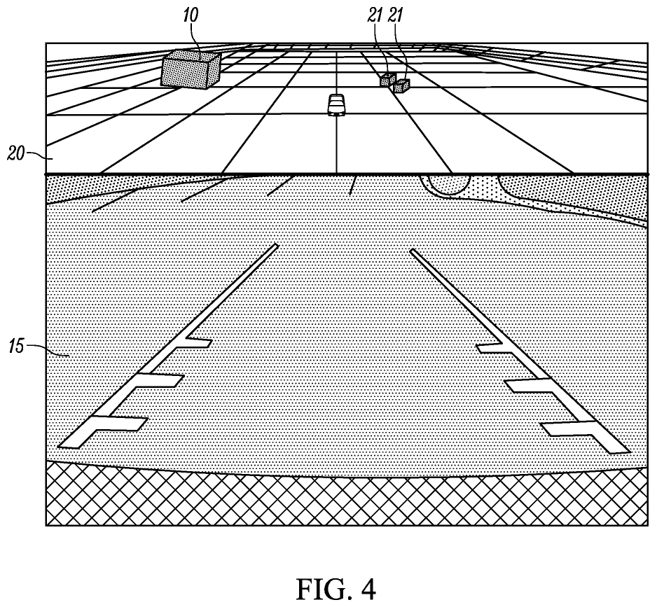

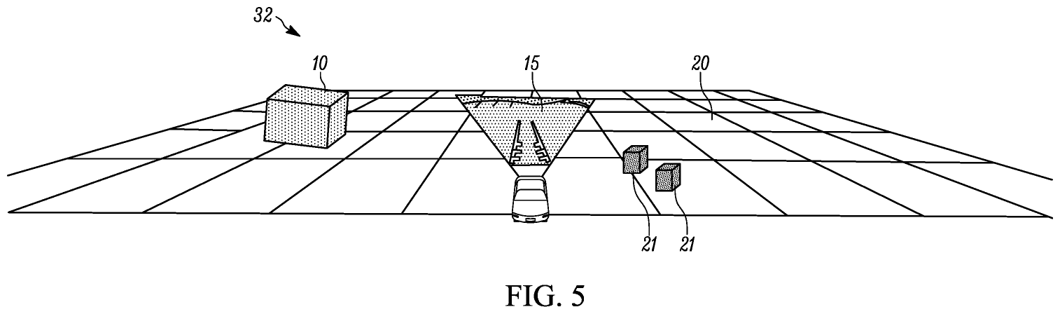

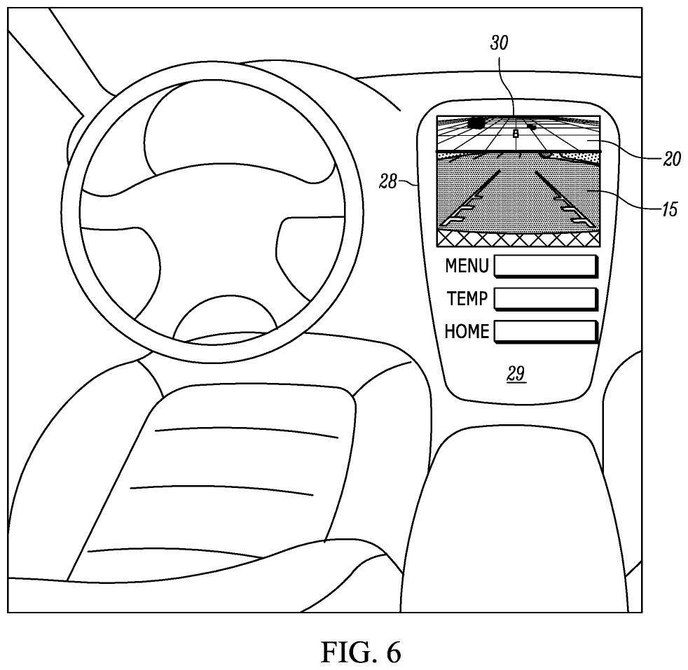

The system 10 further includes a display system 28 that is controlled by the ECU 22. With reference to FIGS. 4 and 6, in the embodiment, the display system 28 can be located at the center console 29 of the vehicle 10 and has display screen 30 controlled by the ECU to display simultaneously to a driver of the vehicle, the image 15 obtained by the rear-view camera 14 and the image 20 developed by the ECU 22. In the embodiment, the images 15 and 20 are shown in a vertically stacked arrangement. However, the images can be disposed in horizontal, side-by-side arrangement. Alternatively, with reference to FIG. 5, the images 15 and 20 can be virtually integrated by the processor circuit 24 into a single, hybrid image 32 and shown on the display screen 30.

Displaying the additional sensor system data (via image 20) adjacent to or integrated with the rear-view camera image 15 at a single location greatly increases the driver's situational awareness during the time when the driver is focused on the back-up image by the driver being able to view a representation of cross-traffic obstacles as detected by the sensor system.

The display screen 30 can be a touch activated screen to enable the driver to change the viewpoint, perspective and/or field of view of the image 20 dynamically to focus on an identified high priority element of the environment, such as a dynamic approaching target or a static wall.

Instead of providing the display screen 30 in the console 29, the display screen can be incorporated in the rear view mirror of the vehicle, or the images 15 and 20 can be shown via a heads-up display system or can be projected onto any surface of the vehicle 10.

Due to the simultaneous display of images 15 and 20 at a common location, the driver can simultaneously monitor traffic object which are both directly behind and crossing the vehicle 10 without the use of an expensive 360 degree camera system (e.g. surround view). In contrast to the surround view camera system, the incusing of the sensor data from non-camera sensors 16, 18 in the view presented to the driver allows increased range and robustness to lighting and weather conditions.

The operations and algorithms described herein can be implemented as executable code within the micro-controller or ECU 22 having the processor circuit 24 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 26 can be implemented, for example, using a non-volatile memory such as a programmable read only memory (PROM) or an EPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A driver assistance system for a vehicle comprising:
a rear view camera constructed and arranged to obtain an image of an area behind a rear of the vehicle,
a non-camera sensor system constructed and arranged to obtain data regarding dynamic or static environmental features at opposing sides of the vehicle,
an electronic control unit electrically connected with the rear view camera and with the sensor system, the electronic control unit being constructed and arranged to create an image from the data received from the sensor system, and
a display system controlled by the electronic control unit and constructed and arranged to display simultaneously to a driver of the vehicle at a single location, the image obtained by the rear-view camera and the image created by the electronic control system.

2. The system of claim 1, the electronic control unit includes a processor circuit constructed and arranged to create the image from the data received from the sensor system.

3. The system of claim 2, wherein processor circuit is constructed and arranged to create a virtual 3D image from the data received from the sensor system.

4. The system of claim 1, wherein the sensor system comprises at least first and second sensors disposed on opposing sides of the vehicle.

5. The system of claim 4, wherein the sensors are radar sensors.

6. The system of claim 4, wherein the sensors are lidar sensors.

7. The system of claim 4, wherein the sensors are ultrasonic sensors.

8. The system of claim 1, wherein the display system includes a display screen on console of the vehicle.

9. The system of claim 1, wherein the display system includes a display screen defined as part of a rear-view mirror of the vehicle.

10. The system of claim 1, wherein the display system is constructed and arranged to project the images onto a surface of the vehicle.

11. The system of claim 8, wherein the display screen is a touch activated screen constructed and arranged to enable a user of the vehicle to dynamically change a viewpoint, perspective and/or field of view of the image created from the data received from the sensor system.

12. A method of monitoring environmental features at opposing sides and at a rear of a vehicle, the method comprising:
obtaining, with a camera, a first image of an area behind a rear of the vehicle,
obtaining, without a camera, data regarding dynamic or static environmental features at opposing sides of the vehicle,
creating a second image from the obtained data, and
displaying simultaneously to a driver of the vehicle, the first and second images at a single location.

13. The method of claim 12, wherein the step of obtaining data includes using first and second sensors disposed on opposing sides of the vehicle to obtain the data.

14. The method of claim 13, wherein the sensors are radar sensors.

15. The method of claim 13, wherein the sensors are lidar sensors.

16. The method of claim 13, wherein the sensors are ultrasonic sensors.

17. The method of claim 14, wherein the step of creating the second image is performed by a processor circuit, with the processor circuit interpreting an intensity of a return radar signal as a height of an object in the second image.

18. The method of claim 12, wherein the step of displaying the first and second images includes displaying the images on a display screen in the vehicle.

19. The method of claim 12, wherein the step of displaying the first and second images includes projecting the images onto a surface of the vehicle.
